(19) United States
(12) Patent Application Publication
(10) Pub. No.: US 2010/0039493 A1
(43) Pub. Date: Feb. 18, 2010

(54) Mobile video headset

(76) Inventors: Mark Kuang Y. Chao, Fountain Valley, CA (US); Kenneth Chow, Monterey Park, CA (US); Keng Chi Li, Galden Grove, CA (US); George Wang, Paramount, CA (US)

Correspondence Address: DAVID AND RAYMOND PATENT FIRM, 108 N. YNEZ AVE., SUITE 128, MONTEREY PARK, CA, 91754, US

(21) Appl. No.: 12/317,103

(22) Filed: Dec. 18, 2008

Related U.S. Application Data
(60) Provisional application No. 61/189,157, filed on Aug. 15, 2008.

(51) Int. Cl. H04N 7/14

(52) U.S. Cl. 348/14.02; 348/E07.077

(57) ABSTRACT

A mobile video headset includes a housing adapted for being worn at an ear of a wearer, an audio unit adapted for communicatively linked to an electronic device for audio signal transmission, and a video unit including an image capturing device provided at the housing for capturing image at a point of view (POV) of the wearer when the housing is worn by the wearer, such that the image capturing device is operated in a hands free manner to capture image what the wearer sees.

### CROSS REFERENCE OF RELATED APPLICATION

This is a non-provisional application of a provisional application having an application No. 61/189,157 and a filing date of Aug. 15, 2008.

### BACKGROUND OF THE PRESENT INVENTION

1. Field of Invention

The present invention relates to a headset, and more particularly to a headset built-in with an image capturing device adjacent to the user's eyes, wherein a user is able to wear the headset with the image capturing device as a hand-free camera and track the movement as the point of view of user's eye level.

2. Description of Related Arts

A wild variety of image capturing devices are known and commercially available. People use the image capturing devices in art, entertainment, and even for security purpose, such as a monitor system.

In order to meet the demands, the image capturing devices are designed to be small, light way for carrying, so that the image capturing devices are further incorporated with portable devices such as camera cell phone. People can just bring the camera cell phone and take pictures anywhere they want and transmit the image to their friends immediately.

The image capturing devices not only can be used in entertainment, but also security purpose. In most of modern tall buildings, companies, or other public places always have the image capturing devices such as monitor system, so that if any accidents happened, the policemen can trace back what was going on and keep the image as evidence.

However, exist inventions still not satisfy the current demands. For instance, when a rock climber wants to capture the amazing scenery of nature, it is inconvenient and might be dangerous for the rock climber to take out the image capturing device from his or her pocket or bag, hold the device stably, and press the bottom to take the picture. It could be even harder and unsafe if the person wants to take a video record, then he or she has to hold the device while climbing. Another example is a security guard or a policeman drawing the gun from a holster in an emergency situation, usually has lots of controversies. Therefore, be able to take a video record readily and use the image capturing device hand-freely is one of the main concerns of developing image capture device.

Consequently, the known devices do not meet all of the current requirements for an image capturing device. There is a need for the image capturing device incorporated with a hand-free, start readily, or automatically on device.

### SUMMARY OF THE PRESENT INVENTION

A main object of the present invention is to provide a headset for mobile video device, wherein an image capturing device is built in with the mobile video headset to provide a hand-free video system.

Another object of the present invention of the mobile video headset is to combine an audio and video signal so that a wearer is able to transmit the audio and video signal at the same time immediately through the mobile communication device such as mobile phone.

A further object of the present invention of the mobile video headset is to provide an image capturing device with an eye level point of view, so that the image capturing device is able to be worn on the ear of the user as the same as the eye level, to track the movement as the point of view of user's eyes. Therefore, the user is able to capture the view in front of his or her eyes in response to the head movement of the wearer.

Another object of the present invention of the mobile video headset is to provide a combined audio and video signal device to incorporate with an electronic device, so that the image taken by the image capturing device of the mobile video headset is able to be saved in an portable device and shows the image on the screen of the portable device.

Still a further object of the present invention of the mobile video headset is to provide an image capturing device so that the lens angle of the image capturing device is adjustable to the angle that the user needs.

Another object of the present invention is to provide a headset for mobile video device, wherein the mobile video headset has an on-and-off switch adapted not only to trigger the video and audio unit of the mobile video headset, but also to save the audio and video signal at the same time.

Another object of the present invention is to provide a headset for mobile video device, wherein the mobile video headset has a memory storage for saving the audio and video signal captured by the mobile video headset, so that the wearer can wear the headset to store and record every precious moment or emergency situation in time under any circumstances by press the on-and-off switch to trigger the mobile video headset.

A further object of the present invention of the mobile video headset is to incorporate the mobile video headset with a remote activator, wherein the remote activator is adapted to remotely control the mobile video headset, such that the remote activator can be further applied on a security system. For instance, to provide the remote control on a holster so that when a security guard or a policeman drawing the gun can trigger the remote activator readily to record the whole even as an evidence and to avoid any controversies of drawing the gun.

Another object of the present invention of the mobile video headset is to provide a very light, inexpensive and easy carried image capturing device, wherein the mobile video headset incorporates with the image capturing device so that the user is able to carry the image capturing device as easy as wear the headset on the ear of the user.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a mobile video headset according to a preferred embodiment of the present invention.

FIG. 2 is a side view of the mobile video headset according to a preferred embodiment of the present invention, illustrating the video headset being worn at an ear of a wearer by a hook operated in a hands free manner to capture image.

FIG. 3 is a top view of the mobile video headset being worn at an ear of the wearer according to a preferred embodiment of the present invention, illustrating the mobile video headset capturing the video signal with a point of view of the wearer.

FIG. 4 is a flow chart diagram of the mobile video headset incorporated with an electronic device according to a preferred embodiment of the present invention, illustrating how the mobile video headset connects to the electronic device and transmits and stores the audio and video signal.

### DETAILED DESCRIPTION OF THE PREFERRED EMBODIMENT

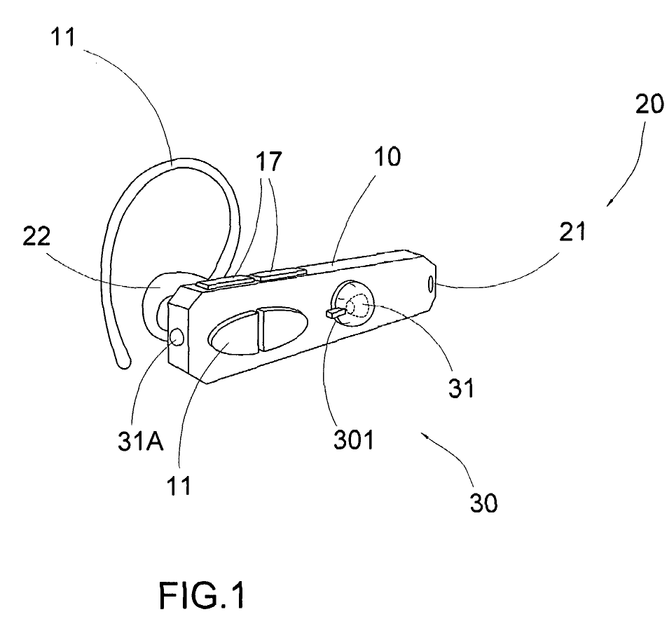

Referring to FIG. 1 of the drawings, a mobile video headset according to a preferred embodiment of the present invention is illustrated, wherein the mobile video headset is adapted for communicatively connecting to an electronic device.

Accordingly, the mobile video headset comprises a housing 10, a wearing means 11 for the wearer wearing the housing 10 at the ear of the wearer, an on-and-off switch 12, and a volume control 13.

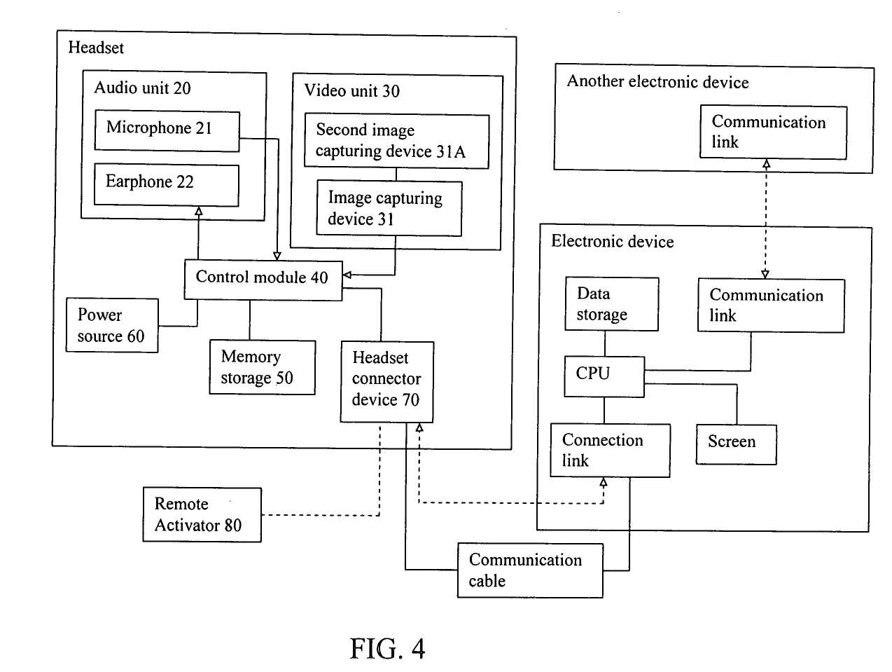

As shown in FIGS. 1 and 4, the mobile video headset further comprises an audio unit 10 which is received in the housing 10, adapted for communicatively transmitting and receiving an audio signal to and from the electronic device, and a video unit 30 supported by the housing 10. The wearing means 11 comprises a hook extended from the housing 10 for being worn at the ear of the wearer. It is appreciated that the wearing means 11 can be an ear plug extended from the housing 10 for being worn at the ear of the wearer.

The audio unit 20 comprises a microphone module 21 for receiving the audio signal from the electronic device and a speaker module 22 for outputting the audio signal to the electronic device. The video unit 30 comprises an image capturing device 31 for capturing the video signal. Accordingly, the on-and-off switch 12 is arranged for operating the audio unit 20 and the video unit 30 provided at the housing 10.

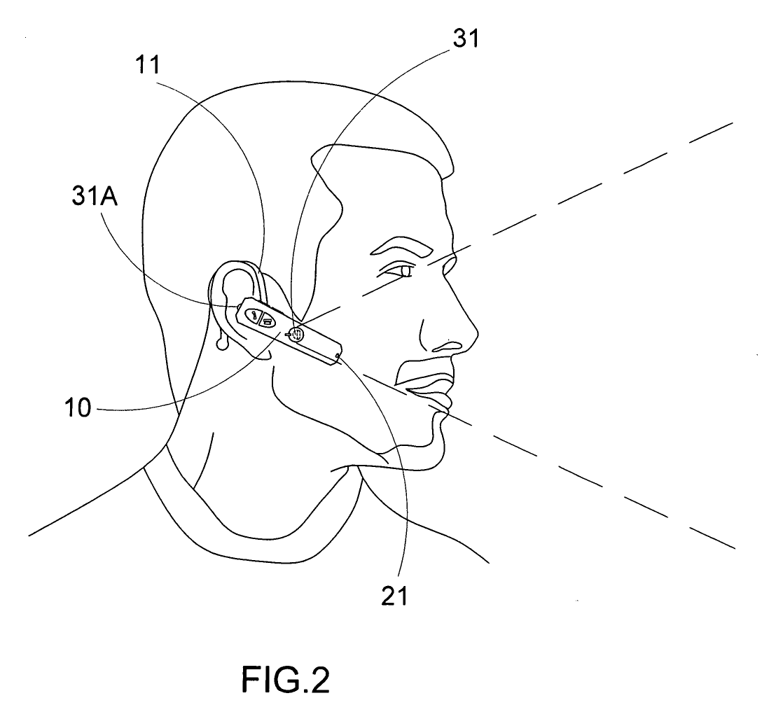

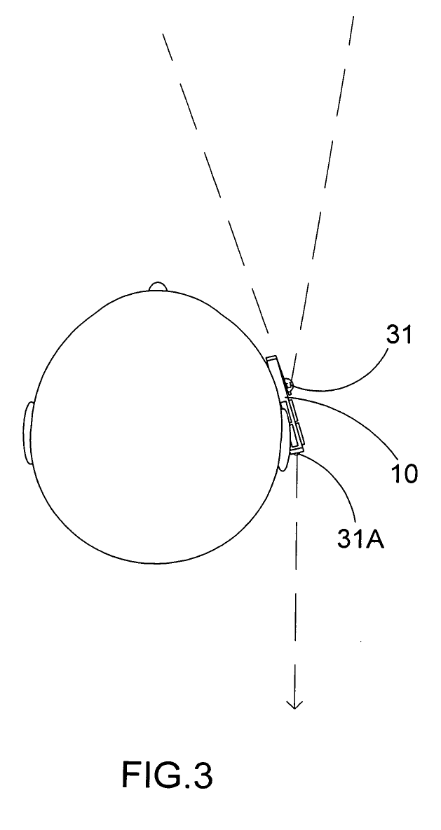

Referring to FIGS. 2 and 3 of the drawings, a hook 11 is adapted for being worn at an ear of the wearer provided at the housing 10 with the audio unit 20 and video unit 30, so that the image capturing device 31 has a capturing view corresponding to a point of view (POV) of the wearer when the housing 10 is worn by the wearer, such that the image capturing device 31 is operated in a hands free manner to capture image what the wearer sees.

Accordingly, the mobile video headset is able to be used as a conventional headset just for transmitting and receiving audio signal through the audio unit 20 of the mobile video headset. In other words, when the electronic device is a mobile phone, the wearer is able to use the headset of the present invention to pick up the call from the mobile phone as a conventional hands free device.

As shown in FIGS. 2 and 3 of drawings, the hook 11 attached to the housing 10 of the mobile headset is worn at an ear by the wearer, wherein the mobile video headset is adjacent to the eyes to catch the point of view of the wear, so that the wearer is able to wear the mobile video headset to track the movement that what the wearer sees in responsive to the eye level of the wearer. The image capturing device 31 of the mobile video headset is located at the housing 10 of the mobile video headset where the image capturing device 31 is able to catch the eye angle view of the wearer. In addition, the image capturing device 31 rotatably coupled with an outer side of the housing 10 via a rotatable joint 301 to selectively adjust the capturing angle of the image capturing device 31 that the wearer needs as shown in FIG. 3. Accordingly, the image capturing device 31 can be rotated 180° at a position that the image capturing device 31 is adapted to capture the image at the rear side of the wearer.

It is worth mentioning that the image capturing device 31 can provide dual capturing angle that one of the capturing angle is set to align with the point of view of the wearer while another capturing angle is set to align with the rear side of the wearer, as shown in FIG. 3. In addition, the image capturing device 31 provides capturing functions of optical/digit zoom, wide angle, or other camera functions.

It is appreciated that a second image capturing device 31A can also be provided at the rear side of the housing 10 at a position that the capturing angle of the second image capturing device 31A is opposite to the capturing angle of the first image capturing device 31. In other words, the first capturing device 31 can capture the image with respect to the point of view of the wearer while the second capturing device 31A can capture the image at the rear side of the wearer.

FIG. 4 is the flow chart diagram of the components of the mobile video headset in the housing 10 for communicatively connecting to the electronic device. The housing 10 of the mobile video headset further comprises a memory storage 50 provided for Audio and Video digital signal storage, a power source 60 to provide the power for the mobile video headset, a headset connection device 70 for connecting the headset to an electronic device like mobile phone, PSP, DA etc. by the means such as Bluetooth, Infrared Ray (IR), Radio frequency, or WiFi, a remote activator 80 to activate the mobile video headset wires or wirelessly, and a control module 40 to coordinate and communicate all the above devices inside the housing 10 of the headset.

According to the preferred embodiment of the present invention, the control module 40 provided at the housing 10 of the mobile video headset is for coordinating and communicating each device inside the housing 10 of the mobile video headset, so that the devices in the housing 10 are able to work correctly as the way we expect. In other words, the control module 40 is communicatively coordinating with the audio unit 20 and the video unit 30.

For audio signal transmission, as shown in FIG. 4, the control module 40 sends out the audio signal to the earphone 22 once the headset connector device 70 is communicatively linked to the electronic device, while the control module 40 receives the audio signal from microphone 21. In other words, the control module 40 is communicatively linked with the audio unit 20 as an audio transceiver for controllably transmitting the audio signal between the audio unit 20 and the electronic device.

For video signal transmission, the control module 40 receives the video signal from the image capturing device 31. Therefore, the audio and video signal can then be saved and/or transmitted through the electronic device to another electronic device, as shown in FIG. 4. In other words, the control module 40 is communicatively linked with the video unit 30 as a video transmitter for controllably transmitting the video signal from the video unit 30 to the electronic device.

Accordingly, the memory storage 50 of the housing 10 of the mobile video headset is a built-in memory or a card slot for an extra memory card inserting into the card slot, so that the audio and video signal is able to be save into the memory storage 50 readily when the mobile video headset has been triggered. It is appreciated that the electronic device can also save the audio signal and the video signal from the audio unit 20 and the video unit 30 respectively when the memory storage 50 is also provided at the electronic device. Therefore, the audio signal and the video signal can be recorded and saved in the memory storage 50 of the mobile video headset and/or in the electronic device.

According to the preferred embodiment of the present invention, the power source 60 is electrically connected to the control module 40 of the mobile video headset is provided to supply the mobile video headset power source, wherein the mobile video headset is rechargeable to store energy.

As shown in FIG. 4, a headset connector device 70 is provided at the housing 10 of the mobile video headset and is communicatively linked with the audio unit 20 and the video unit 30 for wirelessly connecting with the electronic device so as to wirelessly transmitting the audio signal and the video signal to the electronic device. Therefore, the mobile video headset is able to connect to form a connection link of the electronic device through the headset connector device 70, such that the mobile video headset can further connect with the portable electronic device wires or wirelessly such as mobile phone, PSP, PDA etc by the means of Bluetooth, IR, Radio frequency, or WiFi. For example, the headset connector device 70 of the headset connects to the connection link of the mobile phone, wherein the video signal can be displayed on the screen of the mobile phone, and also the audio and video signal can be transmit instantly through the communication link of the mobile phone to another mobile phone through the communication network. In other words, once the electronic device receives the audio signal and the video signal, the electronic device can communicatively link to another electronic device to wirelessly transmit the audio signal and video signal between the electronic devices. The audio and video signal can store at the portable device for further use. Another example is real-time broadcasting audio and video signal by the mobile video headset through the communication device of the electronic device to broadcast lively.

It is worth mentioning that the mobile video headset can be operatively connected to the electronic device through a communication cable such that the audio unit 20 and the video unit 30 can be connected with the electronic device to transmit the audio signal and the video signal to the electronic device through the communication cable. In other words, the connection link between the mobile video headset and the electronic device can be selectively set as a wireless link via the headset connector device 70 or through the communication cable.

Referring to FIGS. 1 and 4 of the drawings, the on-and-off switch 12 provided at the housing 10 of the mobile video headset is adapted for connecting with the control module 40 to turn on and off the mobile video headset readily and save the audio and video signal at the memory storage 50 of the housing of the mobile video headset at the same time, so that the wearer is able to catch the image in time in emergency situation or any other circumstances.

Referring to the FIG. 4 of the flow chart diagram, a remote activator 80 as an external device is provided for remotely controlling the headset connector device 70 of the housing 10 of the mobile video headset. Accordingly, the remote activator 80 is wirelessly linking with the video unit 30 through the headset connector device 70 to selectively activate the video unit 30. For example, the remote activator 80 can be further incorporated with a holster, such that when a policeman or a security guard draws a gun from the holster, the remote activator 80 is remotely triggered to activate the audio unit 20 and the video unit 30 of the mobile video headset to start recording the audio and video signal to the memory storage 50 of the housing 10 of the mobile video headset as an evidence, or connected to the electronic device to wirelessly communicate with the police station computer system.

Accordingly, the present invention of the mobile video headset incorporates an image capturing device 31 with a headset which is well known and commercially available, wherein the present invention of the mobile video headset is adapted for a hands free manner catching the audio and video signal and storing the signal into the memory storage 50 of the housing 10 of the mobile video headset, and for being worn at an ear by the wearer so that the wearer can track the movement of the point of view of the wearer.

The present invention of the mobile video headset further incorporates with an electronic device connected wires or wirelessly to transmit the audio and video signal instantly for a live show or entertainment purpose, and the remote activator 80, wherein the headset is able to be started readily for any emergency circumstances, so that the mobile video headset is applied for the security use.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A mobile video headset for communicatively linking with an electronic device, comprising:
a housing adapted for being worn by a wearer of said electronic device at a position that said housing is supported with respect to an eye level of said wearer;
an audio unit, which is received in said housing, adapted for communicatively transmitting and receiving an audio signal to and from said electronic device; and
a video unit which comprises an image capturing device supported at said housing for communicatively linking to said electronic device, wherein said image capturing device has a capturing angle corresponding to a point of view of said wearer such that said image capturing device is operated in a hands free manner for capturing image what said wearer sees and for sending out a video signal of said image to said electronic device.

2. The mobile video headset, as recited in claim 1, further comprising a control module communicatively coordinating with said audio unit and said video unit, wherein said control module is communicatively linked with said audio unit as an audio transceiver for controllably transmitting said audio signal between said audio unit and said electronic device, and is communicatively linked with said video unit as a video transmitter for controllably transmitting said video signal from said video unit to said electronic device.

3. The mobile video headset, as recited in claim 1, wherein said image capturing device rotatably coupled with an outer side of said housing via a rotatable joint to selectively adjust said capturing angle of said image capturing device with respect to the point of view of said wearer.

4. The mobile video headset, as recited in claim 2, wherein said image capturing device rotatably coupled with an outer side of said housing via a rotatable joint to selectively adjust said capturing angle of said image capturing device with respect to the point of view of said wearer.

5. The mobile video headset, as recited in claim 1, wherein said image capturing device is activated for real-time capturing said image with respect to the point of view of said wearer and for wirelessly sending out said video signal from said electronic device to another said electronic device through a communication network.

6. The mobile video headset, as recited in claim 4, wherein said image capturing device is activated for real-time capturing said image with respect to the point of view of said wearer and for wirelessly sending out said video signal from said electronic device to another said electronic device through a communication network.

7. The mobile video headset, as recited in claim 1, wherein said housing comprises means for detachably wearing said housing at an ear of said wearer.

8. The mobile video headset, as recited in claim 4, wherein said housing comprises means for detachably wearing said housing at an ear of said wearer.

9. The mobile video headset, as recited in claim 6, wherein said housing comprises means for detachably wearing said housing at an ear of said wearer.

10. The mobile video headset, as recited in claim 1, further comprising a memory storage received in said housing to communicatively link with said audio unit and said video unit for saving said audio signal and said video signal.

11. The mobile video headset, as recited in claim 6, further comprising a memory storage received in said housing to communicatively link with said audio unit and said video unit for saving said audio signal and said video signal.

12. The mobile video headset, as recited in claim 9, further comprising a memory storage received in said housing to communicatively link with said audio unit and said video unit for saving said audio signal and said video signal.

13. The mobile video headset, as recited in claim 1, further comprising a headset connector device which is received in said housing and is communicatively linked with said audio unit and said video unit for wirelessly connecting with said electronic device so as to wirelessly transmitting said audio signal and said video signal to said electronic device.

14. The mobile video headset, as recited in claim 6, further comprising a headset connector device which is received in said housing and is communicatively linked with said audio unit and said video unit for wirelessly connecting with said electronic device so as to wirelessly transmitting said audio signal and said video signal to said electronic device.

15. The mobile video headset, as recited in claim 12, further comprising a headset connector device which is received in said housing and is communicatively linked with said audio unit and said video unit for wirelessly connecting with said electronic device so as to wirelessly transmitting said audio signal and said video signal to said electronic device.

16. The mobile video headset, as recited in claim 1, further comprising a remote activator wirelessly linking with said video unit, wherein said remote activator is remotely triggered to activate said video unit for starting capturing said image with respect to the point of view of said wearer.

17. The mobile video headset, as recited in claim 6, further comprising a remote activator wirelessly linking with said video unit, wherein said remote activator is remotely triggered to activate said video unit for starting capturing said image with respect to the point of view of said wearer.

18. The mobile video headset, as recited in claim 15, further comprising a remote activator wirelessly linking with said video unit, wherein said remote activator is remotely triggered to activate said video unit for starting capturing said image with respect to the point of view of said wearer.

19. The mobile video headset, as recited in claim 1, wherein said image capturing device is real-time capturing said image that said video signal thereof is sent to said electronic device and is displayed on a screen of said electronic device in a real-time manner.

20. The mobile video headset, as recited in claim 18, wherein said image capturing device is real-time capturing said image that said video signal thereof is sent to said electronic device and is displayed on a screen of said electronic device in a real-time manner.

21. A method of real-time capturing an image with respect to the point of view of a wearer by a mobile video headset which is communicatively linked to an electronic device, wherein the method comprises the steps of:
(a) wearing said mobile video headset at a position that said mobile video headset is supported at an eye level of said wearer;
(b) activating an audio unit of said mobile video headset to transmit an audio signal between said audio unit and said electronic device;
(c) activating a video unit of said mobile video headset, wherein said video unit comprises an image capturing device having a capturing angle corresponding to the point of view of said wearer, such that said image capturing device is operated in a hands free manner for real-time capturing image what said wearer sees; and
(d) sending out a video signal of said image to said electronic device.

22. The method, as recited in claim 21, wherein said mobile video headset is worn at an ear of said wearer.

23. The method, as recited in claim 22, wherein said audio signal and said video signal are wirelessly sent to said electronic device.

24. The method, as recited in claim 21, further comprising a step of recording said audio signal and said video signal in one of said mobile video headset and said electronic device.

25. The method, as recited in claim 23, further comprising a step of recording said audio signal and said video signal in one of said mobile video headset and said electronic device.

26. The method, as recited in claim 21, further comprising a step of sending out said video signal from said electronic device to another said electronic device through a communication network.

27. The method, as recited in claim 25, further comprising a step of sending out said video signal from said electronic device to another said electronic device through a communication network.

28. The method, as recited in claim 21, further comprising a step of displaying said video signal on a screen of said electronic device in responsive to said image in a real-time manner.

29. The method, as recited in claim 27, further comprising a step of displaying said video signal on a screen of said electronic device in responsive to said image in a real-time manner.

30. The method as recited in claim 21 wherein, in the step (c), said video unit is wirelessly activated by a remote activator.

31. The method as recited in claim 29 wherein, in the step (c), said video unit is wirelessly activated by a remote activator.
